(19) United States
(12) Patent Application Publication
(10) Pub. No.: US 2009/0040600 A1
(43) Pub. Date: Feb. 12, 2009

(54) Telescope Adapter for Supporting a Camera

(75) Inventor: Mrlik Vojtech, Prerov (CZ)

Correspondence Address: LEVINE & MANDELBAUM, 222 Bloomingdale Road, Suite 203, WHITE PLAINS, NY, 10605, US

(73) Assignee: MEOPTA OPTIKA, S.R.O., Prerov (CZ)

(21) Appl. No.: 12/187,507

(22) Filed: Aug. 7, 2008

(30) Foreign Application Priority Data
Aug. 10, 2007 (CZ) PNV 2007-19096

(51) Int. Cl. G02B 23/00

(52) U.S. Cl. 359/363; 359/399

(57) ABSTRACT

A telescope adapter for supporting a camera includes a light beam splitter for receiving light from the telescope and dividing that light into a monitoring bundle of light rays and a recording bundle of light rays, the two bundles of light rays being at angle to each other. The user is permitted to view the monitoring bundle of light rays, and the adapter can support a camera in a position to receive the recording bundle of light rays, so that the user and the camera can receive light from the telescope simultaneously. A first lens system is located between the telescope and the light beam splitter, the first lens system having a total negative power. A monitoring lens system receives and transmits the monitoring bundle of light rays leaving the light beam splitter, and a recording lens system receives and transmits the recording bundle of light rays leaving the beam slitter, both the monitoring and recording lens systems having total positive power. A reflective prism receives the recording bundle of light rays leaving the recording lens system and reflects those light rays toward the camera along a path substantially parallel to the monitoring bundle of light rays.

### BACKGROUND OF THE INVENTION

This invention relates to monitoring or viewing objects or targets with a telescope and also obtaining a picture of the object. Conventionally, this is done in three different ways. One approach is to replace the conventional eyepiece of the telescope with an adapter by means of which a camera can be mounted on the telescope body in such a way that the telescope objective is at the focus plane of the camera. A disadvantage of this system is that without the eyepiece, the object cannot be seen directly through the telescope, but only through the camera mounted on the telescope body. This is not an ideal way of viewing the object using the telescope.

Another approach leaves the telescope eyepiece in place, and employs a holder positioning a camera in front of the eyepiece. Here again, once the camera is in place, the object can only be viewed by observing the camera screen.

Yet a third approach involves a camera permanently mounted on the exit end of the telescope, or permanently integrated with an eyepiece secured to the exit end of the telescope. The problem here is that as camera technology improves, it becomes expensive to replace what amounts to a permanent part of the telescope.

### BRIEF SUMMARY OF THE INVENTION

According to the present invention, an adapter for a telescope is provided which permits direct monitoring or viewing of the object through the telescope, while simultaneously transmitting the image being viewed to a camera capable of recording the image.

This result is achieved by employing a light beam splitter for receiving light from the telescope and dividing that light into two bundles of light rays at an angle to each other. The first bundle of light rays transmits the image directly to an eyepiece on the adapter to permit monitoring of the object. The other bundle of light rays is transmitted to the camera so that the image being viewed can be recorded by the camera at the same time that the image is being monitored through the eyepiece.

Behind the objective of the telescope, there is a first group of lenses with total negative power, followed by the light beam splitter for dividing the light into a monitoring bundle of light rays and a recording bundle of light rays. The monitoring branch of the adapter is provided with a monitoring lens system, with total positive power, behind the light beam splitter, and the recording branch of the adapter is provided with a recording lens system, with total positive power, behind the light beam splitter. Advantageously, the focal length of the recording lens system and the focal length of the monitoring lens system have a ratio in the range of 1.5 to 3.5. Also, the image plane of the recording bundle of light rays is between −1.5 mm and −3.0 mm from the last optical surface through which those light rays pass. Desirably, the first lens system is placed in front of the image plane of the telescope.

Preferably, the light beam splitter permits a portion of the light from the telescope to travel through the monitoring branch along an unchanged axis to the eyepiece, and another portion of the light to be reflected along an axis at an angle to the unchanged axis. In the image plane of the optical system of the telescope and the first group of lenses, a visible mark is provided in the monitoring branch, and at least one of the lenses of the monitoring lens system is moveable along the axis of the monitoring bundle of light rays to permit sharp focusing of the visible mark.

After the recording lens system in the recording branch of the adapter, a reflecting element, such as a reflective prism, is provided to direct the recording bundle of light rays along an axis substantially parallel to the monitoring bundle of light rays.

Advantageously, the length of the path traveled by the light rays from the telescope objective to the last surface of the reflective prism through which the recording bundle of light rays passes is greater than 10 mm.

### BRIEF DESCRIPTION OF THE DRAWINGS

The invention will be described in more detail with reference to the accompanying drawings, in which:

FIG. 1 is a perspective view of spotting scope upon which an adapter according to the present invention is mounted;

FIG. 2 is a cross-sectional view through the adapter showing a camera mounted on it;

FIG. 3 is an end view of the adapter, as viewed from the left side of FIG. 2; and

FIG. 4 is a schematic view showing the operation of the adapter.

### DESCRIPTION OF THE PREFERRED EMBODIMENT

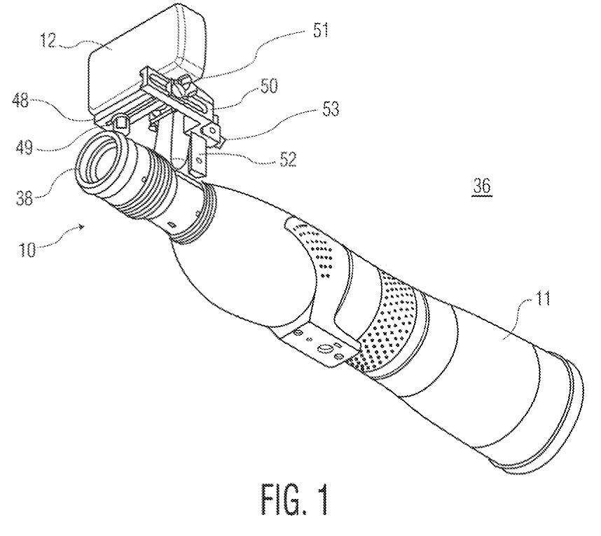

The adapter 10 chosen to illustrate the present invention is shown, in FIG. 1, mounted on a spotting scope 11, which may be of conventional design. The adapter is shown, in FIGS. 1-3, supporting a digital camera 12. Although a spotting scope 11 is shown, the adapter of this invention can be used with any type of telescope employed to magnify distant objects. Also, camera 12, which may be digital in nature, is representative of any sort of device which may be employed to record an image of the object being viewed by the telescope.

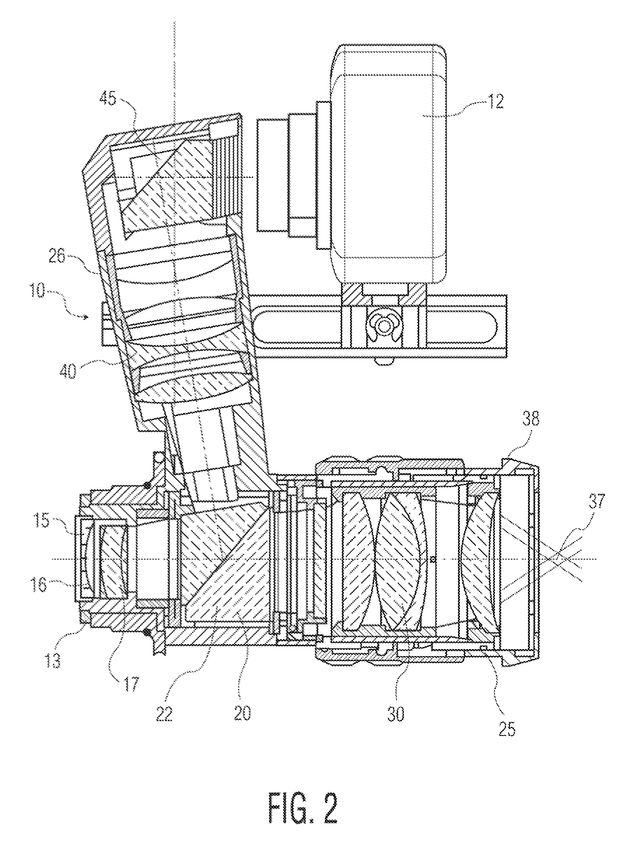

Adapter 10 is provided with a screw thread 13 at one end for securing it to the exit end of scope 11, in the same way that a standard eyepiece would ordinarily be screwed onto the exit end of the scope. Behind the objective 14 (FIG. 4) of the telescope, and in front of the image objective plane, is a first lens system 15 having total negative power. Preferably, this lens system is a non-cemented dispersive doublet, including lenses 16 and 17. Following the first lens system 15 is a light beam splitter 20 comprising two cemented-together prisms 21 and 22, the splitting layer being on the cemented surface of prism 21. The light beam splitter 20 divides the light exiting telescope 11 into a monitoring bundle of light rays 23 and a recording bundle of light rays 24, which travel through a monitoring branch 25 (FIG. 2) and a recording branch 26, respectively, of adapter 10.

Behind the light beam splitter 20, the monitoring branch 25 houses a monitoring lens system 30 having total positive power. In this example, the monitoring lens system comprises four lenses 31, 32, 33, and 34 (FIG. 4). In the image plane of objective 14 and the first group of lenses 15, and thus in the subject-surface of the monitoring lens system 30, a transparent plate 35 is provided, in the monitoring branch, carrying a visible mark. At least one of the lenses forming the monitoring lens system is moveable axially within monitoring branch 25, such as by rotating the portion 36 (FIG. 1) of the scope. This movement permits sharp focusing of the visible mark on plate 35 when the user's eye 37 is placed adjacent to the eyepiece 38.

The recording branch 26 of the adapter extends at an angle to the monitoring branch 25 (see FIG. 2), the angle between the two preferably being about 100°. The recording branch accommodates a recording lens system 40 having total positive power. In this example, the recording lens system comprises four lenses 41, 42, 43, and 44 (FIG. 4). The recording bundle of light rays exiting lens system 40 enters a reflective prism 45 which refracts the recording bundle of light rays toward camera 12 along a path substantially parallel to the path of the monitoring bundle of rays 23. The relation of the focal length of the lens system 40 to the lens system 30 is in the range of 1.5 to 3.5. The image plane of the recording branch for the virtual image is in the range of −1.5 m to −3.0 m for the last optical surface of prism 45.

The length of the path traveled by the light rays from the telescope objective 14 to the last surface of reflective prism 45 through which the recording bundle of light rays passes is greater than 10 mm.

The image created by the objective 14 of the telescope is adjusted by the first lens system 15 for further handling by both the recording and monitoring branches of the adapter. The function of first lens system 15 is the prolongation of the bisector of the objective part of the telescope so that there is space for accommodating the light beam splitter 20, in the placement of camera 12, or other recording equipment, at the end of the recording branch 26. The recording branch creates a virtual image for further processing by camera 12. The reflective prism 45 refracts the optical axis of the recording bundle of light rays in a direction substantially parallel to the monitoring bundle of light rays and also adjusts the image in the sense of altitude orientation. The camera or other recording device receives the refracted recording bundle of light rays. The recording branch is set for creation of a virtual image at a distance, for example, of −2 m suitable for sharpening the focus of conventional cameras placed at the end of the recording branch.

Sharpening the focus of the recording branch takes place in three steps. First, the observer sharpens the visible mark 6 viewed through eyepiece 38 by axial movement of the first two lenses of the monitoring lens system 30. Second, the observer sharpens the object being monitored by way of a focusing movement of the telescope. The plane of the visible mark 6 is placed in coincidence with the object plane of the monitoring branch. For precisely sharpening the focus of the recording branch, it is desirable to use a shorter focal length for the monitoring branch. Third, camera 12 is used to automatically or manually sharpen the focus of the image to be recorded.

It will be seen, therefore, that the camera may be operated to record the image without interrupting monitoring of the object being viewed by the observer.

It is contemplated that the adapter could be arranged to pass all the light exiting the telescope along the monitoring branch 30, and a pivoting element used to momentarily reflect light along the recording branch 40 at the instant that camera 12 is operated to record the image.

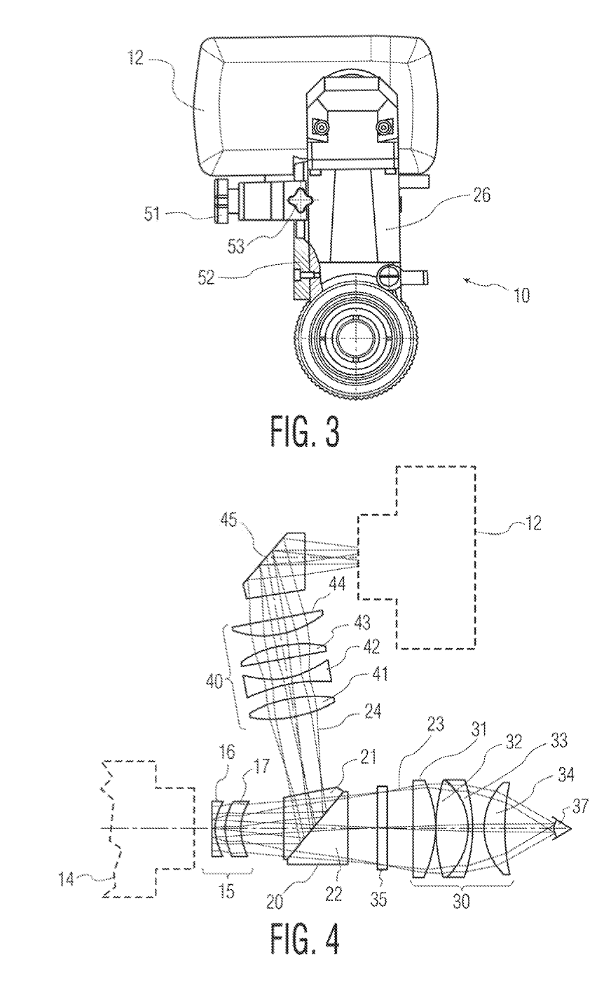

The adapter mount for the camera 12 permits adjustment of the camera position with respect to the remainder of the adapter, and especially with respect to the reflective prism 45, along three mutually orthogonal axes. The camera rests upon a bracket portion 48 (FIG. 1) having a longitudinal slot so that the camera can be adjusted in a horizontal side-to-side direction, and secured in place by a thumb screw 49. Bracket portion 48 is adjustable horizontally along the length of bracket portion 50 to move the camera toward and away from prism 45, and can be secured in place by thumb screw 51. Bracket portion 50 is adjustable vertically along the length of bracket portion 52 (FIGS. 1 and 3) to move the camera up and down, the bracket being securable in place by thumb screw 53.

The invention has been shown and described in preferred, form only, and by way of example, and many variations may be made in the invention which will still be comprised within its spirit. It is understood, therefore, that the invention is not limited to any specific form or embodiment except insofar as such limitations are included in the appended claims.

1. A telescope adapter for supporting a camera, the adapter comprising:
a light beam splitter for receiving light from the telescope and dividing that light into a monitoring bundle of light rays and a recording bundle of light rays, the two bundles of light rays being at an angle to each other,
means for permitting the user to view the monitoring bundle of light rays, and
means for supporting a camera in a position to receive the recording bundle of light rays,
whereby the user and the camera can receive light from the telescope simultaneously.

2. A telescope adapter for supporting a camera as defined in claim 1 including a first lens system between the telescope and the light beam splitter.

3. A telescope adapter for supporting a camera as defined in claim 2 wherein the first lens system has total negative power.

4. A telescope adapter for supporting a camera as defined in claim 1 including a monitoring lens system for receiving and transmitting the monitoring bundle of light rays leaving the light beam splitter.

5. A telescope adapter for supporting a camera as defined in claim 4 wherein the monitoring lens system has total positive power.

6. A telescope adapter for supporting a camera as defined in claim 1 including a recording lens system for receiving and transmitting the recording bundle of light rays leaving the light beam splitter.

7. A telescope adapter for supporting a camera as defined in claim 6 wherein the recording lens system has total positive power.

8. A telescope adapter for supporting a camera as defined in claim 6 including means between the recording lens system and the camera for directing the recording bundle of light rays, toward the camera, along a path substantially parallel to the monitoring bundle of light rays.

9. A telescope adapter for supporting a camera as defined in claim 8 wherein the directing means is a reflective prism.

10. A telescope adapter for supporting a camera as defined in claim 1 including means located between the light beam splitter and the monitoring lens system for providing a visible mark.

11. A telescope adapter for supporting a camera as defined in claim 10 including means for adjusting the monitoring lens system along the axis of the monitoring bundle of rays to sharpen the image of the visible mark as viewed by the user.

12. A telescope adapter for supporting a camera as defined in claim 1 including a monitoring lens system for receiving the monitoring bundle of light rays from the light beam splitter, and a recording lens system for receiving the recording bundle of light rays from the light beam splitter, the focal length of the recording lens system and the focal length of the monitoring lens system have a ratio in the range of 1.5 to 3.5.

13. A telescope adapter for supporting a camera as defined in claim 1 wherein the image plane of the recording bundle of light rays is between −1.5 mm and −3.0 mm from the last optical surface through which said light rays pass.

14. A telescope adapter for supporting a camera as defined in claim 9 wherein the telescope has an objective, and the length of the path traveled by the light rays from the telescope objective to the last surface of the reflective prism through which the recording bundle of light rays passes is greater than 10 mm.

15. A telescope adapter for supporting a camera as defined in claim 1 wherein the means for supporting the camera includes means permitting adjustment of the camera position with respect to the remainder of the adapter along three mutually orthogonal axes.

16. A telescope adapter for supporting a camera, the adapter comprising:
a light beam splitter for receiving light from the telescope and dividing that light into a monitoring bundle of light rays and a recording bundle of light rays, the two bundles of rays being at an angle to each other,
a first lens system between the telescope and the light beam splitter,
a monitoring lens system for receiving and transmitting the monitoring bundle of light rays leaving the beam splitter,
means for permitting the user to view the monitoring bundle of light rays leaving the monitoring lens system,
a recording lens system for receiving and transmitting the recording bundle of light rays leaving the beam splitter, and
means for supporting a camera in a position to receive the bundle of light rays leaving the recording lens system,
whereby the user and the camera can simultaneously receive the monitoring bundle of light rays and the recording bundle of light rays respectively.
